(19) United States
(12) Patent Application Publication
(10) Pub. No.: US 2009/0314590 A1
(43) Pub. Date: Dec. 24, 2009

(54) SYSTEM FOR AUTOMATICALLY ACTUATING THE PARKING BRAKE ON A VEHICLE

(75) Inventors: Ingemar Dagh, Goteborg (SE); Anders Trygg, Onsala (SE)

Correspondence Address: WRB-IP LLP, 1217 KING STREET, ALEXANDRIA, VA, 22314, US

(73) Assignee: Volvo Lastvagnar AB, Goteborg (SE)

(21) Appl. No.: 12/282,888

(22) PCT Filed: Mar. 12, 2007
(86) PCT No.: PCT/SE07/00230

§ 371 Date: Jan. 11, 2009

(30) Foreign Application Priority Data
Mar. 15, 2006 (SE) 0600600-1

(51) Int. Cl. B60T 7/12

(52) U.S. Cl. 188/110

(57) ABSTRACT

A system for automatically actuating the parking brake on a vehicle, such as a truck, includes a parking brake and at least a driver's door lock. The system includes an arrangement for applying said parking brake to an active position as a response to at least said driver's door lock being locked in an active position. The system can include a lock response arrangement which is operable for at least providing a first signal indicating that at least the driver's door lock is locked in an active position; and a hold arrangement for actuating the parking brake to an active position based on the first signal. Thus, it is no longer necessary for a driver to remember to actuate the parking brake, when he or she parks the vehicle, as long as at least the driver's door lock on the vehicle is locked. The manual locking action of the driver's door lock may be further utilized for automatic actuation of the parking brake, i.e. the same manual action may induce two separate functions at the same time. The system increases the effect of the locking the vehicle door by effectively locking the wheels of the vehicle when the parking brake is on, which further reduces the possibility of a vehicle thief removing the vehicle, e.g. by towing it away. As a consequence, the system may be perceived to further provide an improved anti-theft device.

### BACKGROUND AND SUMMARY

The present invention relates to a system for automatically actuating the parking brake on a vehicle, such as a truck, comprising a parking brake. The invention may be applied to various types of vehicles, e.g. trucks and buses, trailers, farm vehicles, construction vehicles, off road vehicles, but also cars, airport vehicles, and the like.

A safety problem encountered with vehicles, especially large vehicles or vehicles transporting heavy equipment or goods, is the fact that the vehicle may inflict damage, if the driver for some reason has not activated or actuated the parking brake, when the vehicle is halted. Omission of actuating the parking brake by drivers has for various reasons, e.g. if the around supporting said vehicle is provided with even a small angle of slope, led to situations, where a vehicle has become a “run-away”, i.e. the vehicle has moved away from its halt position and caused injuries to persons, and damage to buildings and the environment etc. in the vicinity to the vehicle and goods loaded into it.

In U.S. Pat. No. 5,624,352 is described an ignition-controlled parking brake interlock, either of a lever and latch type or as a solenoid type, being actuated by removing the vehicle ignition key. It is a disadvantage that the pulling of the parking brake is not driver controlled, but instead depending directly upon the removal of the ignition key. This is due to the fact that occasionally there may be a need to move the vehicle after removal of the ignition key, e.g. while moving the vehicle for maintenance.

In US 2003/221922 and also in U.S. Pat. No. 4,572,319 are disclosed automatic brake actuation systems for vehicles, in which the fact that the driver leaves the driving seat during short halts with the motor running is utilized for a control system, which receives signals from a seat and a door sensor, and automatically actuates the parking brake, if the seat is left unoccupied and the door is open. Thus, the system is not active if the door is left closed, i.e. the driver must leave the door open for the brake to be “pulled” automatically, which fact may be forgotten or is not convenient to fulfil, e.g. when a truck driver parks the truck, forgets to pull the parking brake for any one reason or another and goes for a break, e.g. to sleep inside the truck cabin or to eat at a road side restaurant.

In the abstract of JP 2003095077 is disclosed an erroneous start prevention device of a tank lorry, in which the parking brake is not energized if a door of a valve operation box is left open with the motor running. This improves the safety for the tank lorry, so that it is not able to run with an open tank, but does not solve the above problem for a vehicle, which has no motor running, but is parked.

Accordingly, it is desirable to provide a safety system, which does not suffer from the disadvantages of the above mentioned prior art systems and may be relied upon for increasing road safety by preventing the parked vehicle from rolling as a run-away, if the driver has not manually pulled the parking brake.

Accordingly, there is provided a system of the initially mentioned kind in a vehicle further comprising at least a driver's door lock, said system comprising means for applying said parking brake to an active position as a response to at least the driver's door lock being locked in an active position.

Thus, it is no longer necessary for a driver to remember to activate the parking brake, when he or she parks the vehicle, as long as at least the driver's door lock on the vehicle is locked. By the invention, it has been realized that the manual locking action of the driver's door lock may be further utilized for automatic actuation of the parking brake, i.e. the same manual action may induce two separate functions at the same time. Further, it has been realized that the system is increasing the effect of the locking the vehicle door by effectively locking the wheels of the vehicle when the parking brake is on, which further reduces the possibility of a vehicle thief removing said vehicle, e.g. by towing it away. As a consequence, the system may be perceived to further provide an improved anti-theft device.

In a preferred embodiment of the invention, said system comprises lock response means, which is operable for at least providing a first signal indicating that at least said driver's door lock is locked in an active position; and hold means for actuating the parking brake to an active position for providing a brake force based on said first signal. Thus, a system according to the invention is realized, which with a minimal number of components is able to provide the improved security for a driver, that the parking brake is always applied, when the vehicle is left parked.

In another embodiment of the invention, said system further comprises communication means, such as antenna circuits or wire, for providing said first signal from said lock response means to said hold means. Depending on type of vehicle, door lock and parking brake system, and distance between the positions of said lock response means and said hold means an appropriate communication line between these may then advantageously be selected accordingly.

In yet another embodiment of the invention, the lock response means are provided at least adjacent to and in communication with at least said driver's door lock for indicating that at least said driver's door lock is locked in an active position. Thus, a conventional mechanical vehicle door lock and corresponding key may be utilized for the present invention, and a reliable indication of a locked or locking driver's door lock is provided. The lock response means may then be provided as e.g. an electrical or mechanical sensor unit, in ways known to the skilled person. Accordingly, the initiation of the automatic parking brake actuating system according to the invention is performed by the singular action of manually turning the key inside the vehicle entrance door lock.

In a further embodiment of the invention, said system further comprises a remote-control locking and unlocking arrangement in communication with said lock response means for indicating that at least said driver's door lock is locked in an active position. This may be a conventional remote-control locking and unlocking arrangement, e.g. such as a push-button key-ring attachment, in which case the initiation of the automatic parking brake actuating system may be performed by the singular action of manipulating said arrangement.

In a further embodiment of the invention, at least said driver's door lock is provided integrally with a vehicle central locking system and adjacent to and in communication with said lock response means. Accordingly, the initiation of the automatic parking brake actuating system may be performed by the singular action of actuating the central locking system, e.g. from any interior lifter or exterior key.

In another embodiment of the invention, at least said lock response means is provided in the fuse central of the vehicle. Accordingly, this eases maintenance and service, and provides for improved access to electrical communication lines to hold means and other systems of the vehicle.

In a further embodiment of the invention, said hold means are operable to automatically actuate the parking brake irrespective of whether the manually operated parking brake initiator has in fact been actuated. Thus, the automatic initiation of the parking brake is independent of the fact whether or not the parking brake initiator has in reality been actuated by the driver, i.e. the system is available and active in all circumstances, and the parking brake may be pulled manually by the driver, also when the motor is running. Further, and more importantly, the system according to the invention provides for actuation of the parking brake when parked, even when the driver has not manually activated the parking brake initiator. Thus, no deactivation of the automatic system according to the invention is necessary during the life time of the vehicle, which improves the possibility that the system is available when needed.

In yet a further embodiment of the invention, said parking brake comprises a pneumatic brake comprising an air pressure line with a valve for applying the brake, and said hold means is operable to activate said pneumatic brake by draining said air pressure line by said valve to the brake actuator. As an alternative, said parking brake comprises a hydraulic brake comprising a liquid pressure line and a valve for actuating the parking brake, and said hold means is operable to actuate said hydraulic brake by draining said liquid pressure line by said valve to the brake actuator.

Accordingly, the parking brake is able to be actuated automatically by minor modifications of conventional parking brake systems. Obviously, other types of hold means are conceivable, e.g. for other types of parking brake systems, such as electronic or mechanical hold means for corresponding types of parking brakes systems, or any combination thereof. Further, other known systems for providing automatic initiation of the parking brake may alternatively be used, e.g. using solenoids or the like.

In another embodiment of the invention, said hold means is provided integrally with said parking brake. Thus, only a minor modification is necessary to said parking brake system for providing the brake force needed from said parking brake as a reaction to said first signal.

In another embodiment of the invention, said lock response means further is operable to provide a second signal in reaction to a deactivation input; and said system further being provided with release means for de-actuating the parking brake based on said second signal. Thus, the system may be deactivated automatically, e.g. such as when the driver unlocks for driving away, or when he has the doors locked due to personal safety reasons, or the like.

In yet a further embodiment of the invention, the deactivation input is at least said driver's door lock being unlocked in an inactive position. Accordingly, the system is not active, when the one or more door locks are being unlocked, which is often the case when the driver enters for driving the vehicle.

In a further embodiment of the invention, said system is operable to remain with an actuated parking brake, if the manually operated parking brake initiator is pulled and/or released while at least said driver's door lock is locked in an active position. Accordingly, the road safety system may be used for improving the security against thieves, because if any of the door locks are still locked while the parking brake initiator is pulled, this may indicate, that an operator other than the driver may be attempting to steal the vehicle. Obviously, alternatively, the system may be responsive to such pulling or releasing of the parking brake initiator, even when the door locks are in the active position, in which case the conventional parking brake initiator effectively provides the deactivation input.

In a further embodiment of the invention, the system further comprises a switch and/or an interface for providing the driver to provide said deactivation input. Accordingly, the driver is able to control if said system is to be switched to a state in which the parking brake is de-actuated, which improves system versatility. The driver deactivation input may preferably be protected by the provision of a code or key, or by the fact that said switch is hidden or protected in other ways. Thus, the release of the parking brake is exclusively driver operated, and not available to possible thieves, which improves the possibility of using the system as an anti-theft device.

In a further embodiment of the invention, said system further comprises a starter switch entry detection device for providing said deactivation input when the vehicle ignition key or card is entered into the vehicle starter switch. Accordingly, said device ensures that the deactivation is dependent on whether the driver starts the motor of the vehicle, in which case the parking brake is released automatically. This reduces the probability of increased wear on the brake shoes due to inadvertently driving while the parking brakes are still applied.

In a further embodiment of the invention, said system further comprises driver alert means for an indication of the parking brake being automatically actuated by the system. Accordingly, a driver is being notified of the automatic system being active, and the fact that further action needs to be taken in order to release the parking brake. A conventional parking brake alert means, such as the same indicator lamp, or alternatively a separate automatic system alert lamp may be utilized. This also reduces the probability of increased wear on the brake shoes due to inadvertently driving while the parking brakes are still applied.

In a further embodiment of the invention, the driver alert means are visual, audible and/or tactile devices. Accordingly, an effective indication is delivered to the driver of the automatic system being on, and the devices may include devices already present on the vehicle, e.g. anti-theft devices providing a loud indication, or less loud devices such as computer voices or buzzers.

In a further embodiment of the invention, the lock response means and the hold means are provided integrally, said lock response means further being provided with a receiving antenna in order to be responsive to a wireless signal issued by said remote-control locking and unlocking arrangement. Accordingly, the system is adapted for easy retrofitting to an existing vehicle, or as a separate vehicle sub system.

In a further embodiment of the invention, the vehicle is a heavy vehicle, in particular a truck. Thus, a particular advantageous effect is achieved, because the road safety is improved more, than with smaller, less heavy vehicles, e.g. not carrying a load.

### BRIEF DESCRIPTION OF THE DRAWINGS

In the following the invention is described in more detail with reference to the accompanying schematic drawings, in which:

FIG. 1 shows an overview of a first embodiment of a system according to the invention fitted on a truck;

FIG. 2A-2C illustrates the operation of a spring loaded parking brake; and

FIG. 3A-3B shows a second, third and fourth embodiment of a system according to the invention.

### DETAILED DESCRIPTION

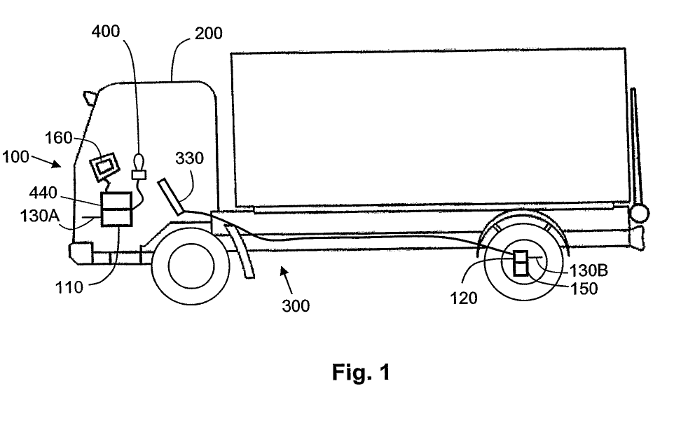

In the following, the system according to the invention is explained in connection with the vehicle being a truck 200, as shown in FIG. 1. However, it is realized by the invention, that the present system is also applicable to any vehicle comprising a parking brake and a drivers door lock, and the illustrated example is thus not to be perceived as limiting the present invention in scope. As the problem being solved indicates, the invention is in particular advantageous for heavy vehicles, such as buses or large trucks, e.g. pulling semi-trailers or road trains, because there is a risk of these inflicting substantial damage if the vehicle is not parked correctly.

In a preferred embodiment, the vehicle is a truck or tractor unit, which may in turn be pulling a trailer or a semi-trailer. In trucks or tractors the parking brake is applied, e.g. by releasing the air pressure, if these brakes are air operated, and disengaged when air pressure is supplied. This is performed by providing a spring loaded parking brake for the leading and/or drive axles, which spring is brought into action, if the air pressure is released. This is an emergency feature which ensures that if air pressure to either unit is lost, that unit will not lose all braking capacity and become uncontrollable. For the truck/tractor, two air lines control the trailer unit. An “emergency” or main air supply line pressurizes the trailer's air tank and disengages the emergency brake, and a second “service” line controls the brake application. The emergency brake of the trailer unit may be provided as a spring induced brake on one axle.

It has by the invention been realized, that also the emergency brake on a truck/tractor unit may be perceived as a parking brake in the sense of this invention, by the automatic activation or actuation of the parking brake according to the invention.

In FIG. 1 is shown a truck 200, which is fitted with a parking safety system 100 according to the present invention.

Said truck 200 comprises a pneumatic parking brake 300 which in a conventional way may be pulled or engaged in an active position when an operator, e.g. the driver, actuates a manually operated parking brake initiator 330, and similarly be released or engaged in an inactive position by the opposite actuation. Alternatively, the parking brake 300 may be another type of conventional parking brake, e.g. a mechanical or electronic brake system using pneumatic or hydraulic transferred brake force. The parking brake may be working on one or more wheels or set of wheels of the vehicle, as it is commonly employed for a truck. Hydraulic parking brakes are generally being used for medium size vehicles, and mechanical parking brakes are generally used for smaller vehicles. Recently, also combination parking brakes have also become available, such as electro-hydraulic parking brakes.

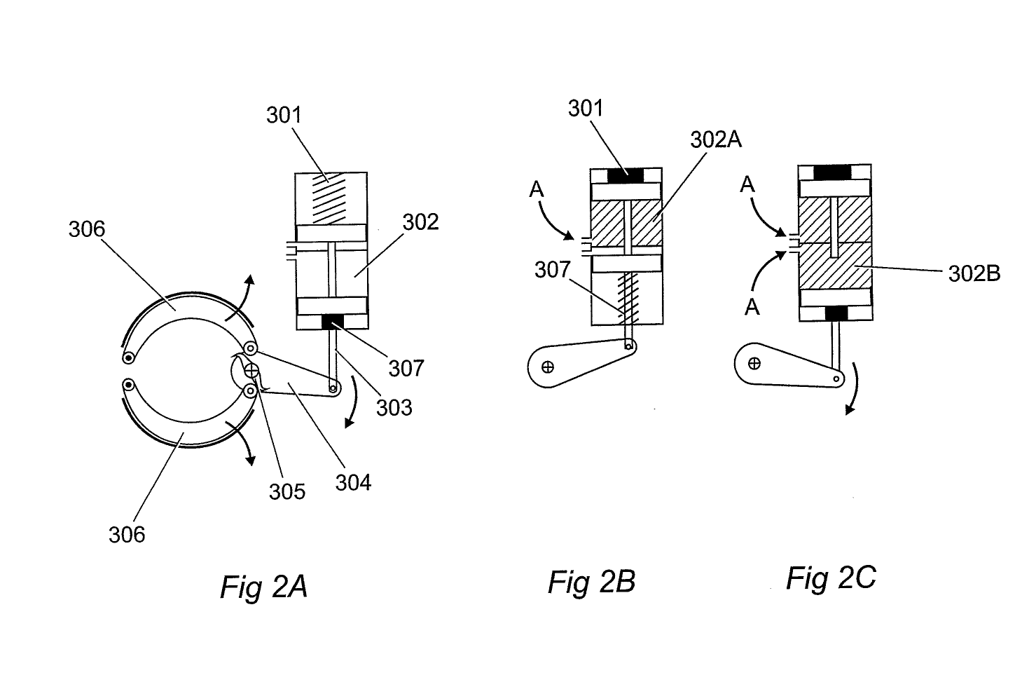

Many newer trucks are equipped with spring-activated parking brakes that also serve as an emergency braking system. FIG. 2A-2C illustrates the operation of spring operated parking brakes. When the truck is parked (no air pressure), as shown in FIG. 2 A, a heavy spring 301 inside the brake chamber 302 applies the brakes by moving the pushrod 303, which in turn moves a lever 304 (slack adjuster), turning an S-cam 305, which forces the brake pads 306 outwards until they contact the drum (not shown). After the engine is started, the driver supplies air A to the top half 302A of the chamber as shown in FIG. 2B, compressing the heavy spring 301. A smaller return spring 307 releases the brake. Now, when the brake pedal is depressed, supplying service air A to the bottom half 302B of the chamber, it may work as a driving brake system, as shown in FIG. 2C. Accordingly, the spring brakes will “lock” the brakes in an emergency (air pressure lost) situation, but also allow controlled application for parking (no air pressure due to no running motor).

The term “manually operated parking brake initiator” is to mean any device suitable for driver activation and/or deactivation of the parking brake, e.g. comprising a pulling/resetting handle manually operable by a driver, but may also mean any other device for this purpose, such as driver activation and deactivation switches or push buttons provided in the truck cabin, as it is used in some countries.

Further, said vehicle 200 comprises at least one vehicle door lock 400, e.g. one lock provided in the entrance door to the driver's cabin or driver's door. It has by the invention been realised, that the locking of any one or more of the other entrance doors to the vehicle may provide a parking brake activation input to the system according to the invention, but preferably, since a driver most often is locking the driver's door first, this door lock has been selected as the initiator of the system according to the invention.

Many different types of conventional vehicle door locks 400 are presently available and suitable for utilization with the present invention, such as electrically or mechanically operated door locks being either remotely-controlled or directly controlled by a key, which locks may be provided integral with a vehicle central locking system 440, which may optionally further comprise or be in communication with vehicle anti-theft alarm devices alerting the surroundings by an audible or visual signal during unauthorized entry in the vehicle, and ignition lock devices preventing the motor from being turned on without e.g. a code entry, key or card, and the like.

Locking and unlocking of the locks of the doors of the vehicle and in particular the lock in the door leading to the driver's seat or driver's door may be conventionally performed. For example by manually turning a vehicle door lock key in said lock or each individual entrance door lock, or alternatively remotely from the vehicle actuating an activation button provided or integrated with the vehicle lock keys, e.g. by using wire-less technology provided with a button device in e.g. a key-ring for the ignition key, which a driver carries with him away from the vehicle when parked. Other ways of engaging the door locks in an active or inactive position are known and conceivable, e.g. actuating an open/close button provided upon the exterior of the vehicle.

Preferably, the system 100 comprises lock response means 110 for providing an activation input or first signal as a response to at least said driver's seat door lock 400 being locked, and hold means 120 for actuating the parking brake 300 based on said first signal. The lock response means 110 and the hold means may communicate in different ways for transferring at least said first signal, e.g. wirelessly or by wire. Accordingly, the lock response means 110 may comprise an antenna circuit 130A for providing a wireless first signal or a communication line for transmitting said first signal or any combination thereof, and correspondingly the hold means 120 may be provided with the respective receiving means, e.g. another antenna circuit 130B. Any type of antenna being adapted for transmitting, respectively receiving RF, IR or other electro-magnetic waves may be used, e.g. mobile telephone signals or electronic wireless network signals, in the form of at least said first signals, where said signal or signals may be provided as being within a specific frequency or amplitude interval, or may comprise a specific signal combination or contain coded or direct information to be identified by the hold means 120 as first signals. The skilled person will know how to apply an appropriate technique for the communication between said lock response means 110 and hold means 120, which is dependent upon the application and placement on the vehicle thereof.

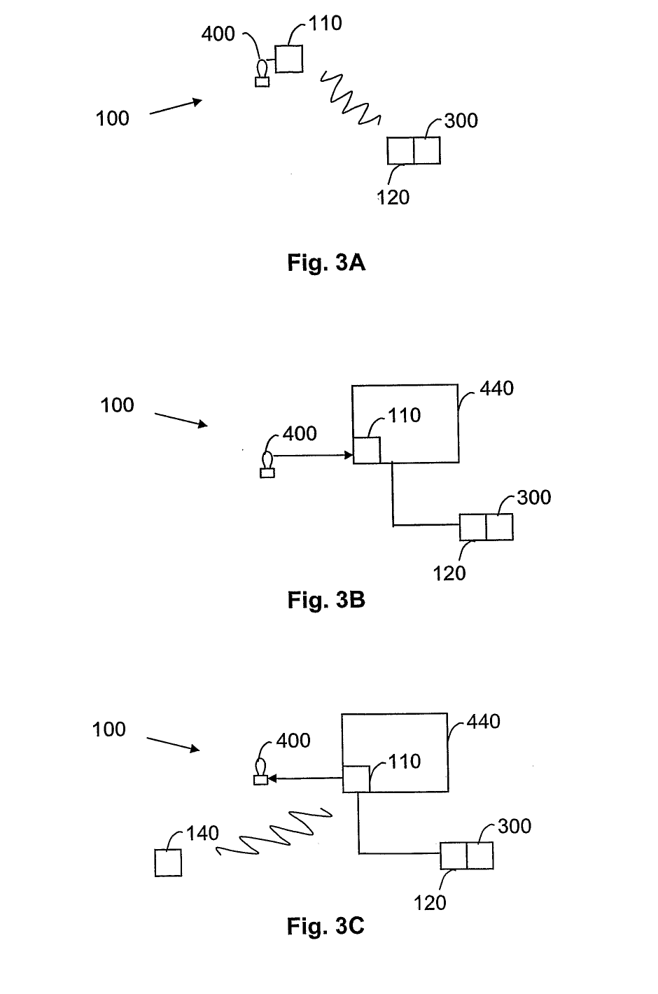

Conveniently, the lock response means 110 may be placed in the electrical distribution centre of the vehicle, and/or in the instrumentation, and/or within a common receiver central within the vehicle, but the exact location is of minor importance to the invention. In FIG. 1, the lock response means 110 are provided integrally with a central locking system 440, which is in communication with driver's lock 400, in such a way that when the lock is engaged in the active position, the lock response means 110 is operable to wirelessly transmit said first signal to the hold means 120. See FIG. 3A-3C and a description thereof below describing further embodiments of the system 100 according to the invention.

The hold means 120 for the parking brake 300 may, as shown in FIG. 1 be located within the parking brake system of the engaging wheels, which parking brake system may advantageously be a spring actuated parking brake as illustrated in FIG. 2A-2C. The hold means 120 is a brake actuation mechanism, which may vary according to which type of parking brake is employed, i.e. pneumatic, hydraulic, mechanical etc. As mentioned above, pneumatic parking brakes comprise an air pressure line with a valve for applying the brake, e.g. by using a spring actuated parking brake, when the air pressure is released. In a similar manner, when a hydraulic parking brake is employed, valve operation may also be used for actuation of the brake force. In a preferred embodiment, said hold means 120 is operable to actuate said valve and thus apply the braking force to said one or more wheels, e.g. by being provided as a valve actuator.

FIGS. 3 A, 3B and 3 C show three different exemplary embodiments of said system 100 according to the present invention.

FIG. 3A illustrates an embodiment of the system according to the invention comprising lock response means 110 and hold means 120 for actuating said parking brake 300 as a direct consequence of at least the driver's door lock 400 being turned to an active position, i.e. being locked by a conventional vehicle door key. When the lock is being engaged in the active position, or alternatively when the lock has reached the active position, the lock response means 110, which is provided adjacent to said door lock, provides a first wireless signal, indicated with a wavy line, to the hold means 120 provided integrally with the parking brake system 300 near the engaging wheels. Accordingly, said hold means 120 are applying brake force on said parking brake 300 in response to said first signal. The lock response means 110 may be provided in the vehicle's electrical distribution centre, or integrally with at least one of the door locks, e.g. including the driver's door lock 400, or adjacent to said door lock, e.g. provided as an electrical or mechanical sensor unit, in ways known to the skilled person.

FIG. 3B illustrates an embodiment of the system according to the invention comprising lock response means 110 and hold means 120 for actuating said parking brake 300 in reaction to at least the driver's door lock 400 being turned to an active position, i.e. the vehicle central locking system 440 being actuated by a vehicle door key, e.g. being turned in the driver's door lock. The lock response means 110 are provided integrally with the central locking system 440 and communicating by wire (indicated as lines in FIG. 3B) to said hold means 120 provided integrally with the parking brake system 300 for an application of said brake force by enabling the hold means 120.

FIG. 3 C illustrates an embodiment of the system according to the invention comprising lock response means 110 and hold means 120 for actuating said parking brake 300 in reaction to the central locking system 440 being actuated, i.e. all doors being locked, including the driver's door lock 400 by a conventional wireless remote-control locking and unlocking arrangement 140 externally from the vehicle 200, such as a conventional hand held, key-ring applicable push-button device. Otherwise, the system is similarly arranged as in FIG. 3B.

Other combinations of communication between, placement of and form of indicator and hold means 110, 120 are conceivable to the skilled person. For example, the lock response means 110 and the hold means 120 may alternatively be provided integrally, which will ease a retrofitting of a system according to the invention to an existing vehicle, e.g. by fitting an antenna to said lock response means 110 and adapting it to be responsive to the wireless signal issued by the existing remote-control locking arrangement 140.

As illustrated in FIG. 1, said lock response means 110 may further be operable to receive a second signal in reaction to a deactivation input, e.g. transmitted from any vehicle door lock or the central locking system 440 when said vehicle door lock 400 is being unlocked; and there may further be provided release means 150 for de-actuating the parking brake 300 based on said second signal.

For an automatic parking brake deactivation, the second signal may be transmitted by the same or another communication line from the same lock response means 110 at the door lock 400, when it is unlocked by the driver, e.g. by depressing a button on the remote-control locking arrangement 140 before he enters the truck 200. The second signal is transmitted to said release means 150 for a de-actuation or release of the parking brake 300. The release means 150 may comprise hydraulic or pneumatic pump means depending on brake type, e.g. being connected to the running motor of the vehicle, when being turned on.

A deactivation input may also be provided while the door lock is locked, e.g. by depressing a deactivation button provided e.g. hidden in the driver's cabin, or by releasing the parking brake 300 by manually activating or deactivating the manually operated parking brake initiator 330, or by entering in the ignition key or card into the starter switch. This is to ensure that the parking brake force is not applied, when a driver is present in the vehicle getting ready for driving, while the doors are locked. This may be the case, e.g. when a driver is sleeping in the truck, or when a driver is getting ready to depart, and for any reason, e.g. personal safety, locks the entry doors before driving the vehicle away.

In an alternative embodiment, if the door locks including lock 400 are locked and the ignition key is not inserted in the starter switch, an actuation of the manually operated parking brake initiator 330 will not de-actuate the parking brake 300. This improves the effect of anti-theft functionality of the system 100.

Further, a driver alert means 160 may be provided with an indicator such as a display or lamp, which provides a driver or operator the information that the automatic parking brake actuation system 100 is activated, i.e. the parking brakes are pulled. This may also be indicated by audible or tactile driver alert devices for sending out e.g. a continuous tone or alarm, or other driver alert signal.

As an alternative, a control panel is provided in communication with the lock response means 110 for enabling a user interface for the driver, providing both driver alert means 160 and said deactivation input. The control panel may further include a numeric alphanumeric keypad (not shown) for allowing the driver to e.g. input said deactivation by entering in a security code in order to release the parking brake, either in the same action as de-actuating, or in a separate action for prematurely de-actuating the parking brake, e.g. during scheduled maintenance or towing.

The system 100 may be retrofitted to an existing vehicle, or may be provided as a vehicle sub system, or may in fact be provided integrally with a vehicle central locking system and/or parking brake system.

It has by the invention been realized, that the automatic parking brake actuation system 100 according to the invention may be supplied as a supplement to or integral with the central locking system, in which latter case the actuation of the parking brake in the active position may be one of two or more safety locks or alarms provided in the vehicle, or alternatively the only lock provided.

1. A system for automatically actuating the parking brake on a vehicle, comprising a parking brake and at least a driver's door lock, the system comprising means for applying the parking brake to an active position as a response to at least the driver's door lock being locked in an active position.

2. A system according to claim 1 comprising lock response means which is operable for at least providing a first signal indicating that at least the driver's door lock is locked in an active position, and hold means for actuating the parking brake to an active position for providing a brake force based on the first signal.

3. A system according to claim 2, further comprising communication means, such as antenna circuits or wire, for providing the first signal from the lock response means to the hold means.

4. A system according to claim 2, wherein the lock response means are provided at least adjacent to and in communication with at least the driver's door lock for indicating that at least the driver's door lock is locked in an active position.

5. A system according to claim 2, further comprising a remote-control locking and unlocking arrangement in communication with the lock response means for indicating that at least the driver's door lock is locked in an active position.

6. A system according to claim 2, wherein at least the driver's door lock is provided integrally with a vehicle central locking system (440) and adjacent to and in communication with the lock response means.

7. A system according to claim 2, wherein at least the lock response means is provided in the electrical distribution center of the vehicle.

8. A system according to claim 2, where the hold means are operable to automatically actuate the parking brake irrespective of whether the manually operated parking brake initiator has in fact been activated.

9. A system according to claim 2, wherein the parking brake comprises a pneumatic brake comprising an air pressure line with a valve for applying the brake, and the hold means is operable to actuate the pneumatic brake by draining the air pressure line by the valve to the brake actuator.

10. A system according to claim 2, wherein the parking brake comprises a hydraulic brake comprising a liquid pressure line and a valve for actuating the parking brake, and the hold means is operable to actuate the hydraulic brake by draining the liquid pressure line by the valve to the brake actuator.

11. A system according to claim 2, wherein the hold means is provided integrally with the parking brake.

12. A system according to claim 2, wherein the lock response means further is operable to provide a second signal in reaction to a deactivation input; and the system further being provided with release means for de-actuating the parking brake based on the second signal.

13. A system according to claim 12, wherein the deactivation input is the at least driver's door lock being unlocked in an inactive position.

14. A system according to claim 12, the system being operable to remain with an actuated parking brake, if the manually operated parking brake initiator is pulled and/or released while at least the driver's door lock is locked in an active position.

15. A system according to claim 12, further comprising a switch and/or an interface for the driver to provide the deactivation input.

16. A system according to claim 12, further comprising a starter switch entry detection device for providing the deactivation input when the vehicle ignition key or card is entered into the vehicle starter switch.

17. A system according to claim 1, further comprising driver alert means for an indication of the parking brake being automatically actuated by the system.

18. A system according to claim 17, wherein the driver alert means are visual, audible and/or tactile devices.

19. A system according to claim 2, wherein the lock response means and the hold means are provided integrally, the lock response means further being provided with a receiving antenna in order to be responsive to a wireless signal issued by the remote-control locking and unlocking arrangement.

20. A system according to claim 1, where the vehicle is a heavy vehicle.
